(19) United States
(12) Patent Application Publication
(10) Pub. No.: US 2020/0036473 A1
(43) Pub. Date: Jan. 30, 2020

(54) Uplink Control Information And Physical Uplink Control Channel Transmission Enhancement In Mobile Communications

(71) Applicant: MediaTek Singapore Pte. Ltd., Singapore (SG)

(72) Inventors: Jozsel Nemeth, Cambridge (GB); Abdellatif Salah, Cambridge (GB); Mohammed S Aleabe Al-Imari, Cambridge (GB); Raghavendra Madanahally Ramakrishna, Cambridge (GB)

(21) Appl. No.: 16/510,967

(22) Filed: Jul. 14, 2019

Related U.S. Application Data
(60) Provisional application No. 62/702,437, filed on Jul. 24, 2018.

(51) Int. Cl. H04L 1/00; H04L 1/20; H04W 72/04; H04L 5/10; H04L 5/00; H04L 1/18

(52) U.S. Cl. CPC H04L 1/0026; H04L 1/203; H04L 1/1812; H04L 5/10; H04L 5/0051; H04W 72/0413

(57) ABSTRACT

Various solutions for enhancing uplink control information (UCI) and physical uplink control channel (PUCCH) transmission with respect to user equipment and network apparatus in mobile communications are described. An apparatus may generate a plurality of channel state information (CSI) reports. The apparatus may determine a priority of each of the plurality of CSI reports according to a service type. The apparatus may detect a collision between at least two CSI reports. The apparatus may transmit a CSI report with a higher priority to a network node.

### CROSS REFERENCE TO RELATED PATENT APPLICATION(S)

The present disclosure is part of a non-provisional application claiming the priority benefit of U.S. Patent Application No. 62/702,437, filed on 24 Jul. 2018, the content of which is incorporated by reference in its entirety.

### TECHNICAL FIELD

The present disclosure is generally related to mobile communications and, more particularly, to uplink control information (UCI) and uplink physical control channel (PUCCH) transmission enhancement with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR), ultra-reliable and low latency communications (URLLC) is supported for emerging applications that demands high requirements on end-to-end latency and reliability. A general URLLC reliability requirement is that a packet of size 32 bytes shall be transmitted within 1 millisecond end-to-end latency with a success probability of 10⁻⁵. URLLC traffic is typically sporadic and short whereas low-latency and high-reliability requirements are stringent. For example, the control reliability of URLLC has to be stricter than the data reliability which is up to 10⁻⁶ block error rate (BLER).

As for uplink, UCI may comprise a scheduling request (SR), hybrid automatic repeat request (HARQ) information, and a channel quality indicator (CQI). The UCI may be carried by physical uplink control channel (PUCCH) or physical uplink shared channel (PUSCH). HARQ based transmission is essential to achieve the strict reliability requirements for URLLC with efficient use of radio resources. For HARQ based downlink transmission, the probability for successful downlink transmission will heavily depend on the reliability of the uplink control channel (e.g., PUCCH) that carries acknowledgement/negative acknowledgement (ACK/NACK) feedback. Thus, design of PUCCH should ensure very low impact of HARQ transmission errors.

The current PUCCH frameworks or UCI transmitting mechanisms fail to provide sufficient flexibility to meet the reliability/latency requirements of URLLC. Accordingly, how to reduce latency and improve reliability for UCI and PUCCH transmission becomes an important issue for some specific service types in the newly developed wireless communication network. Therefore, it is needed to provide proper schemes to further enhance UCI transmission and PUCCH performance.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to UCI and PUCCH transmission with respect to user equipment and network apparatus in mobile communications.

In one aspect, a method may involve an apparatus generating a plurality of channel state information (CSI) reports. The method may also involve the apparatus determining a priority of each of the plurality of CSI reports according to a service type. The method may further involve the apparatus detecting a collision between at least two CSI reports. The method may further involve the apparatus transmitting a CSI report with a higher priority to a network node.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising generating a plurality of CSI reports. The processor may also perform operations comprising determining a priority of each of the plurality of CSI reports according to a service type. The processor may further perform operations comprising detecting a collision between at least two CSI reports. The processor may further perform operations comprising transmitting, via the transceiver, a CSI report with a higher priority to the network node.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example table under schemes in accordance with implementations of the present disclosure.

FIG. 4 is a block diagram of an example communication apparatus and an example network apparatus in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to UCI and PUCCH transmission enhancement with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In NR, URLLC is supported for emerging applications that demands high requirements on end-to-end latency and reliability. A general URLLC reliability requirement is that a packet of size 32 bytes shall be transmitted within 1 millisecond end-to-end latency with a success probability of 10⁻⁵. URLLC traffic is typically sporadic and short whereas low-latency and high-reliability requirements are stringent. For example, the control reliability of URLLC has to be stricter than the data reliability which is up to 10⁻⁶ BLER.

As for uplink, UCI may comprise an SR, HARQ information, and a CQI. The UCI may be carried by PUCCH or PUSCH. HARQ based transmission is essential to achieve the strict reliability requirements for URLLC with efficient use of radio resources. For HARQ based downlink transmission, the probability for successful downlink transmission will heavily depend on the reliability of the uplink control channel (e.g., PUCCH) that carries ACK/NACK feedback. Thus, design of PUCCH should ensure very low impact of HARQ transmission errors.

The current PUCCH frameworks or UCI transmitting mechanisms fail to provide sufficient flexibility to meet the reliability/latency requirements of URLLC. Accordingly, how to reduce latency and improve reliability for UCI and PUCCH transmission becomes an important issue for some specific service types in the newly developed wireless communication network. It is needed to further enhance UCI transmission and PUCCH performance.

In view of the above, the present disclosure proposes a number of schemes pertaining to UCI and PUCCH transmission enhancement with respect to the UE and the network apparatus. According to the schemes of the present disclosure, enhancement to PUCCH format 3 may be provided to reduce latency. On the other hand, enhancement to multiplexing UCI over PUCCH format 3 or PUSCH may also be provided for latency critical UCI. Furthermore, enhancement to CSI priority rule may be provided to prioritize high priority service types.

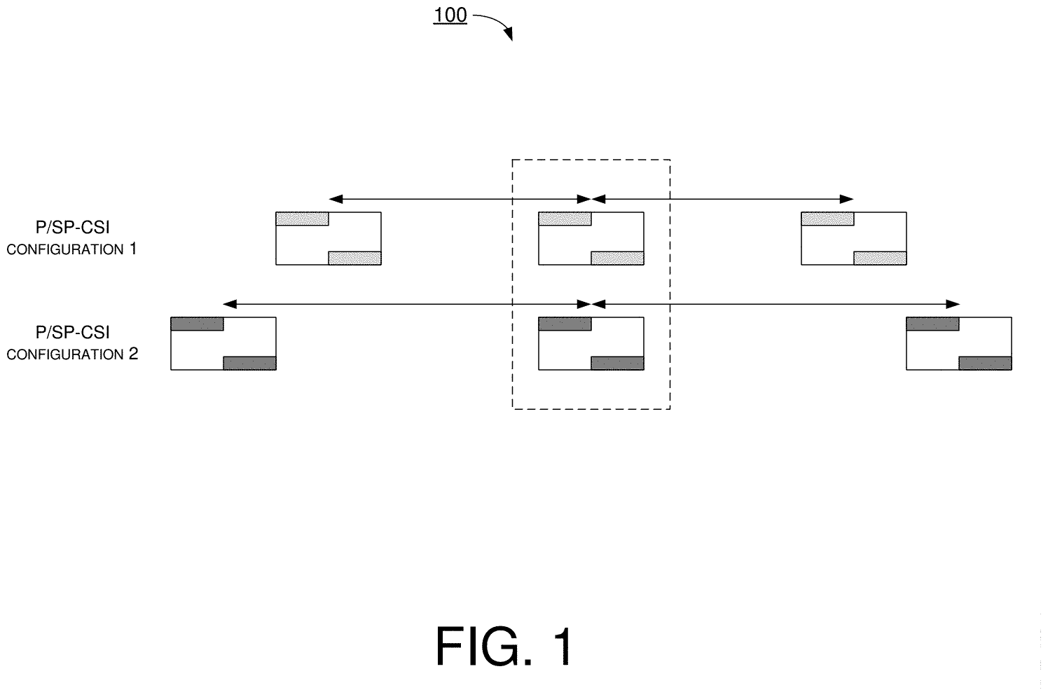

Generally, URLLC services require more up-to-date and reliable channel information than enhanced mobile broadband (eMBB) services. By increasing the frequency of periodic CSI report sending, the receiver will receive more accurate reports with greater reliability. eMBB services should be de-prioritized in the case of conflicting scheduling. FIG. 1 illustrates an example scenario 100 under schemes in accordance with implementations of the present disclosure. Scenario 100 involves a UE and a network node, which may be a part of a wireless communication network (e.g., an LTE network, an LTE-Advanced network, an LTE-Advanced Pro network, a 5G network, an NR network, an IoT network or an NB-IoT network). When the UE is configured with periodic CSI (P-CSI) or semi-persistent CSI (SP-CSI) reports having different period lengths (e.g., P/SP-CSI configuration 1 and P/SP-CSI configuration 2), in some periods their respective configured PUCCH resources will overlap in time, as shown in FIG. 1. In an event that multi-CSI reporting is configured, the two reports may be multiplexed onto a combined PUCCH resource. Otherwise, one of them needs to be dropped. To give URLLC traffic high priority, the dropping rule should account for the configured channel quality indicator (001) table and favor the lower block error rate (BLER) target. When PUCCH resources assigned to two P/SP CSI reports overlap in time, in an event that one of them is configured with a CQI table using lower BLER target than the other, then the one with the higher BLER target should be dropped.

Specifically, the UE may be configured to generate a plurality of CSI reports. The UE may determine a priority of each of the plurality of CSI reports according to a service type. For example, the UE may determine a high priority to the CSI report associated with the URLLC service and may determine a low priority to the CSI report associated with the eMBB service. The UE may detect a collision between at least two CSI reports. The UE may transmit the CSI report with the higher priority to the network node. The UE may drop the CSI report with the lower priority. In determining the priority, the UE may be configured to determine the priority of each of the plurality of CSI reports according to a CQI table. The CQI table may associate with a BLER target. Thus, the UE may be configured to determine the priority of each of the plurality of CSI reports according to the BLER target. For example, in an event that one P/SP CSI configuration is using CQI table with BLER target 10⁻⁵ and the other P/SP CSI configuration is using CQI table with BLER target 10⁻¹ , then the UE may be configured to drop the CSI report for BLER target 10⁻¹.

In some implementations, CSI reports may be associated with a priority value Pri_{iCSI}(y, k, c, s)=2·N_{cells}·Mₛ·y+N_{cells}·Mₛ·c+s+4·N_{cells}·Mₛ·z. y=0 may be configured for aperiodic CSI reports to be carried on PUSCH. y=1 may be configured for semi-persistent CSI reports to be carried on PUSCH. y=2 may be configured for semi-persistent CSI reports to be carried on PUCCH. y=3 may be configured for periodic CSI reports to be carried on PUCCH. k=0 may be configured for CSI reports carrying layer 1-reference symbol received power (L1-RSRP). k=1 may be configured for CSI reports not carrying L1-RSRP. c is the serving cell index. N_{cells} is the value of the higher layer parameter maxNrofServingCells. s is the parameter reportConfigID. Mₛ is the value of the higher layer parameter maxNrofCSI-ReportConfigurations. z=0 may be configured for URLLC services. z=1 may be configured for other services. A first CSI report may be determined to have priority over second CSI report in an event that the associated Pri_{iCSI}(y, k, c, s) value is lower for the first report than for the second report. Two CSI reports are determined to collide in an event that the time occupancy of the physical channels scheduled to carry the CSI reports overlap in at least one orthogonal frequency division multiplexing (OFDM) symbol and are transmitted on the same carrier. When the UE is configured to transmit two colliding CSI reports, the CSI report with higher Pri_{iCSI}(y, k, c, s) value shall not be transmitted by the UE.

In some implementations, the UE may receive a configuration of a PUCCH format 3. The UE may be configured to transmit the PUCCH format 3 in a 2-symbol or 3-symbol duration to the network node by using Discrete Fourier Transform-Spread Orthogonal Frequency Division Multiplexing (DFT-S-OFDM). The short duration PUCCH format may provide low latency transmission for URLLC. DFT-S-OFDM may provide lower peak-to-average power ratio (PAPR) and benefit cell-edge UE. 2-symbol duration PUCCH format 3 may offer URLLC services in low SCS scenarios for cell-edge UE's sending PUCCH over multiple physical resource blocks (PRBs). 3-symbol duration PUCCH format 3 may provide greater reliability. For example, in 3-symbol duration PUCCH format 3, 1-symbol data and 2-symbol demodulation reference signal (DMRS) may be used for more robust demodulation. Alternatively, 2-symbol data and 1-symbol DMRS may be used for more robust encoding. Frequency hopping may not be applicable in either case.

In some implementations, the PUCCH Format 2 may be configured to use DFT-S-OFDM. DFT-S-OFDM implies replacing frequency division multiplexing (FDM) DMRS by time division multiplexing (TDM) DMRS. Frequency hopping and repetition may not be applicable. For example, RRC configuration may be used to configure parameter DFT-S-OFDM-with-Format2={true, false}. In an event that the parameter is set to be true, PUCCH format 2 transmissions may be sent with DFT-S-OFDM. In an event that the parameter is set to be false, PUCCH format 2 transmissions may be sent with cyclic prefix (CP)-OFDM. In another example, the DFT-S-OFDM-with-Format2 parameter may be configured through layer 1 signalling (e.g., DCI).

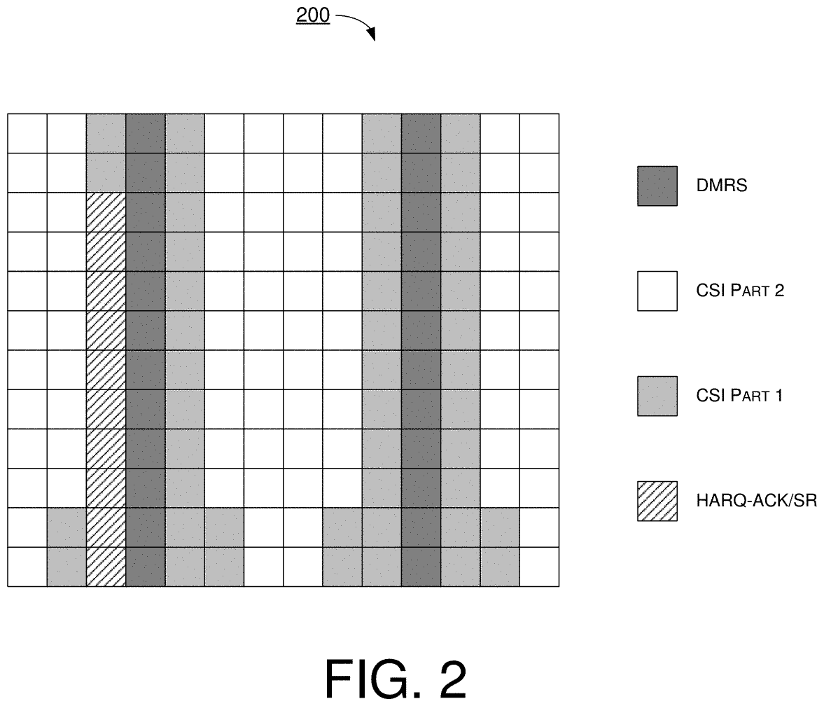

In some implementations, the UCI corresponding to URLLC services may be mapped around the first DMRSs for minimal latency and maximum reliability. The UCI may comprise at least one of an SR, HARQ information, and a CQI. FIG. 2 illustrates an example scenario 200 under schemes in accordance with implementations of the present disclosure. Scenario 200 involves a UE and a network node, which may be a part of a wireless communication network (e.g., an LTE network, an LTE-Advanced network, an LTE-Advanced Pro network, a 5G network, an NR network, an IoT network or an NB-IoT network). For URLLC services, the UCI (e.g., HARQ-ACK and SR information), which is latency critical, is encoded separately from CSI part 1 and mapped next to the first DMRSs. The applied encoding may compensate for the lack of diversity gain from frequency hopping between the two halves of the PUCCH resource. The gain in latency may amount to 2-7 symbols depending on the PUCCH duration and DMRS configuration.

Specifically, the UE may receive the configuration of the PUCCH format 3 or the PUSCH. The UE may be configured to map the UCI corresponding to URLLC services around the first DMRSs of the PUCCH format 3 or the PUSCH. The UE may be configured to multiplex the UCI over the PUCCH format 3 or the PUSCH. Then, the UE may transmit the PUCCH format 3 or the PUSCH to the network node.

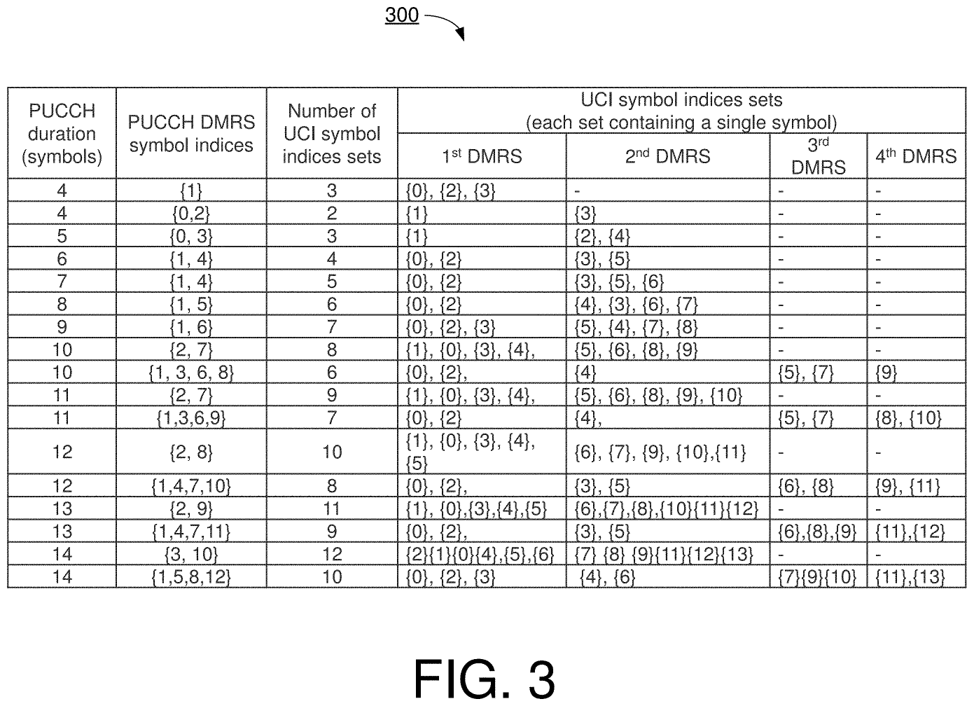

In some implementations, some new encoding and mapping options may be defined for the case when HARQ-ACK/SR and CSI are sent over the same format 3 PUCCH resource. For example, one of the options is to encode and map the HARQ-ACK/SR sequence and the CSI sequence separately. Alternatively, FIG. 3 illustrates an example table 300 under schemes in accordance with implementations of the present disclosure. Table 300 illustrates PUCCH DMRS and UCI symbols. The order of sets may be further tuned for a better trade-off between reliability and latency. The UE may use table 300 with HARQ-ACK/SR sequence. Alternatively, a fully configurable table may be configured through radio resource control (RRC) signalling. In the map, each symbol set may contain a single symbol. The latency may take precedence over the reliability in the priority order of symbols. The latency of a symbol may be impacted by the number and position of DMRSs waited for its decoding. The reliability of a symbol may be impacted by the minimum distance and number of DMRSs used for its decoding. Alternatively, the UE may fill in any remaining resource elements (REs) of the last incomplete symbol using first bits of CSI (e.g., part 1) sequence. Alternatively, the UE may eliminate used symbols before using it for the mapping of the CSI sequence. The UE may select at least one of the above options according to an RRC configuration.

In some implementations, the UE may encode and map the HARQ-ACK/SR/CSI part 1 sequence and the CSI part 2 sequence separately. The UE may use an RRC configured table or a fixed table (e.g., table 300) with the HARQ-ACK/SR/CSI part 1 sequence. The UE may fill in any remaining REs of the last incomplete symbol using first bits of CSI (e.g., part 2) sequence. The UE may eliminate used symbols before using it for the mapping of the CSI part 2 sequence.

In some implementations, the UE may receive the configuration of the PUCCH format 3 or the PUSCH. The UE may be configured to modulate the UCI with the DMRSs of the PUCCH format 3 or the PUSCH. The UE may transmit the PUCCH format 3 or the PUSCH to convey the UCI to the network node. The UCI may comprise one or two bits of at least one of the SR, the HARQ information, and the CQI. Specifically, when only a few bits (e.g. 1 or 2 bits) of HARQ-ACK/SR are sent over the same format 3 PUCCH resource as CSI, some new encoding and mapping options may be used. For example, the UE may encode and map the CSI sequence separately from the HARQ-ACK/SR. Alternatively, the DMRS may be shifted cyclically to convey the information. For example, 2 shifts may convey 1-bit HARQ, and 4 shifts may convey 2-bit HARQ. Alternatively, the UE may be preconfigured with different DMRS sequences (e.g., by RRC signaling) to be used for different HARQ bit combinations. Alternatively, the HARQ information may be transmitted over successive DMRSs across time. For example, 2-bit HARQ may be communicated by 2 DMRSs carrying 1 bit information each. The UE may select at least one of the above options according to an RRC configuration.

### Illustrative Implementations

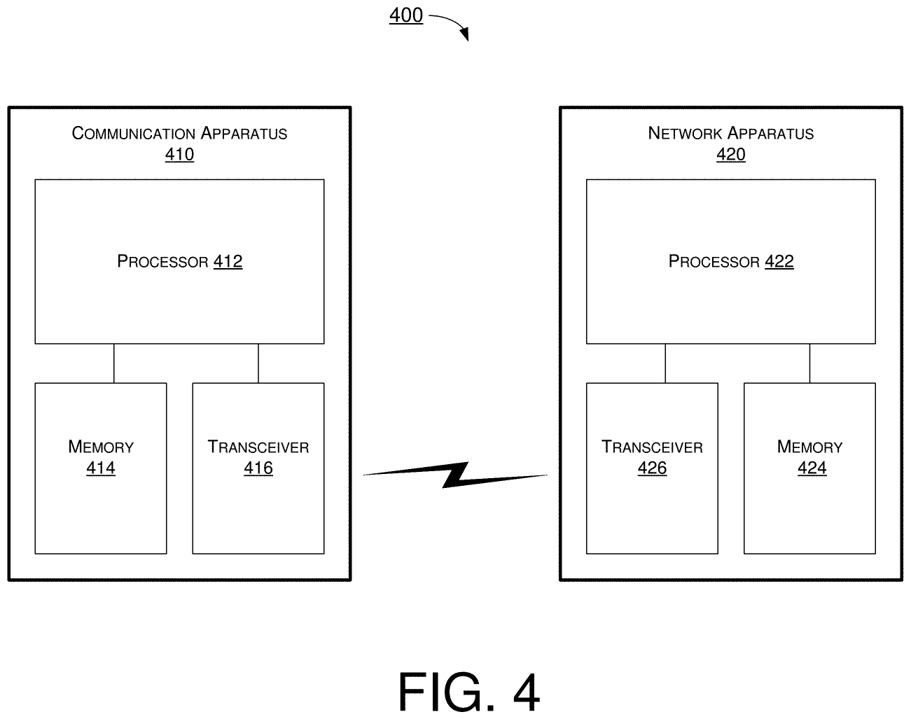

FIG. 4 illustrates an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to UCI and PUCCH transmission enhancement with respect to user equipment and network apparatus in wireless communications, including schemes described above as well as process 500 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT or NB-IoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a base station, a small cell, a router or a gateway. For instance, network apparatus 420 may be implemented in an eNodeB in an LTE, LTE-Advanced or LTE-Advanced Pro network or in a gNB in a 5G, NR, IoT or NB-IoT network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more RISC or CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including power consumption reduction in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, processor 412 may be configured to generate a plurality of CSI reports. Processor 412 may determine a priority of each of the plurality of CSI reports according to a service type. For example, processor 412 may determine a high priority to the CSI report associated with the URLLC service and may determine a low priority to the CSI report associated with the eMBB service. Processor 412 may detect a collision between at least two CSI reports. Processor 412 may transmit, via transceiver 416, the CSI report with the higher priority to network apparatus 420. Processor 412 may drop the CSI report with the lower priority. In determining the priority, processor 412 may be configured to determine the priority of each of the plurality of CSI reports according to a CQI table. The CQI table may associate with a BLER target. Thus, processor 412 may be configured to determine the priority of each of the plurality of CSI reports according to the BLER target. For example, in an event that one P/SP CSI configuration is using CQI table with BLER target 10⁻⁵ and the other P/SP CSI configuration is using CQI table with BLER target 10⁻¹ , then processor 412 may be configured to drop the CSI report for BLER target 10⁻¹.

In some implementations, processor 412 may receive a configuration of a PUCCH format 3. Processor 412 may be configured to transmit, via transceiver 416, the PUCCH format 3 in a 2-symbol or 3-symbol duration to network apparatus 420 by using DFT-S-OFDM. The short duration PUCCH format may provide low latency transmission for URLLC. DFT-S-OFDM may provide lower PAPR and benefit cell-edge communication apparatus. For example, in 3-symbol duration PUCCH format 3, processor 412 may use 1-symbol data and 2-symbol DMRS for more robust demodulation. Alternatively, processor 412 may use 2-symbol data and 1-symbol DMRS for more robust encoding.

In some implementations, processor 412 may receive, via transceiver 416, the configuration of the PUCCH format 3 or the PUSCH. Processor 412 may be configured to map the UCI corresponding to URLLC services around the first DMRSs of the PUCCH format 3 or the PUSCH. Processor 412 may be configured to multiplex the UCI over the PUCCH format 3 or the PUSCH. Then, processor 412 may transmit, via transceiver 416, the PUCCH format 3 or the PUSCH to network apparatus 420.

In some implementations, some new encoding and mapping options may be defined for the case when HARQ-ACK/SR and CSI are sent over the same format 3 PUCCH resource. For example, processor 412 may encode and map the HARQ-ACK/SR sequence and the CSI sequence separately. Alternatively, processor 412 may use table 300 with HARQ-ACK/SR sequence. Alternatively, processor 412 may be configured with a fully configurable table through RRC signalling. Alternatively, processor 412 may fill in any remaining REs of the last incomplete symbol using first bits of CSI (e.g., part 1) sequence. Alternatively, processor 412 may eliminate used symbols before using it for the mapping of the CSI sequence. Processor 412 may select at least one of the above options according to an RRC configuration.

In some implementations, processor 412 may encode and map the HARQ-ACK/SR/CSI part 1 sequence and the CSI part 2 sequence separately. Processor 412 may use an RRC configured table or a fixed table with the HARQ-ACK/SR/CSI part 1 sequence. Processor 412 may fill in any remaining REs of the last incomplete symbol using first bits of CSI (e.g., part 2) sequence. Processor 412 may eliminate used symbols before using it for the mapping of the CSI part 2 sequence.

In some implementations, processor 412 may receive, via transceiver 416, the configuration of the PUCCH format 3 or the PUSCH. Processor 412 may be configured to modulate the UCI with the DMRSs of the PUCCH format 3 or the PUSCH. Processor 412 may transmit, via transceiver 416, the PUCCH format 3 or the PUSCH to convey the UCI to the network node. The UCI may comprise one or two bits of at least one of the SR, the HARQ information, and the CQI. Specifically, when only a few bits (e.g. 1 or 2 bits) of HARQ-ACK/SR are sent over the same format 3 PUCCH resource as CSI, some new encoding and mapping options may be used. For example, processor 412 may encode and map the CSI sequence separately from the HARQ-ACK/SR. Alternatively, processor 412 may cyclically shift the DMRS to convey the information. For example, 2 shifts may convey 1-bit HARQ, and 4 shifts may convey 2-bit HARQ. Alternatively, processor 412 may be preconfigured with different DMRS sequences (e.g., by RRC signaling) to be used for different HARQ bit combinations. Alternatively, processor 412 may transmit the HARQ information over successive DMRSs across time. For example, 2-bit HARQ may be communicated by 2 DMRSs carrying 1 bit information each. Processor 412 may select at least one of the above options according to an RRC configuration.

### Illustrative Processes

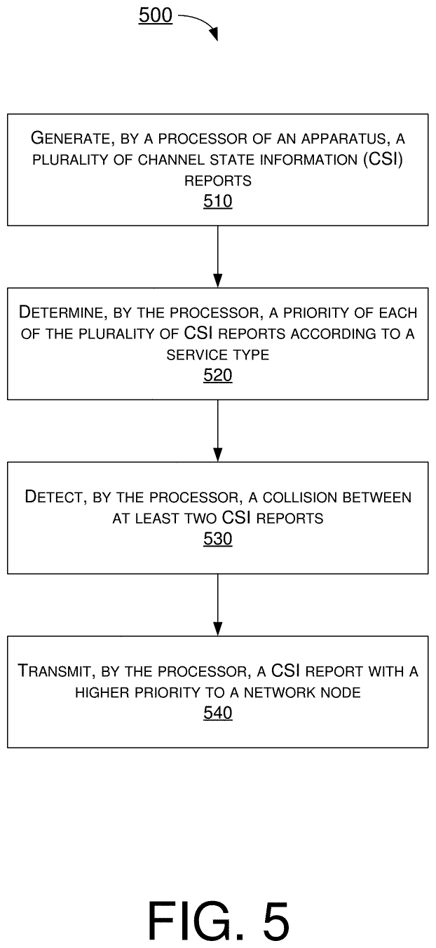

FIG. 5 illustrates an example process 500 in accordance with an implementation of the present disclosure. Process 500 may be an example implementation of above scenarios, whether partially or completely, with respect to UCI and PUCCH transmission enhancement with the present disclosure. Process 500 may represent an aspect of implementation of features of communication apparatus 410. Process 500 may include one or more operations, actions, or functions as illustrated by one or more of blocks 510, 520, 530 and 540. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At 510, process 500 may involve processor 412 of apparatus 410 generating a plurality of CSI reports. Process 500 may proceed from 510 to 520.

At 520, process 500 may involve processor 412 determining a priority of each of the plurality of CSI reports according to a service type. Process 500 may proceed from 520 to 530.

At 530, process 500 may involve processor 412 detecting a collision between at least two CSI reports. Process 500 may proceed from 530 to 540.

At 540, process 500 may involve processor 412 transmitting a CSI report with a higher priority to a network node.

In some implementations, process 500 may involve processor 412 dropping a CSI report with a lower priority.

In some implementations, process 500 may involve processor 412 determining the priority of each of the plurality of CSI reports according to a CQI table.

In some implementations, process 500 may involve processor 412 determining the priority of each of the plurality of CSI reports according to a BLER target.

In some implementations, process 500 may involve processor 412 determining a high priority to a CSI report associated with a URLLC service.

In some implementations, process 500 may involve processor 412 receiving a configuration of a PUCCH format 3. Process 500 may also involve processor 412 transmitting the PUCCH format 3 in a 2-symbol or 3-symbol duration to the network node by using DFT-S-OFDM.

In some implementations, process 500 may involve processor 412 receiving a configuration of a PUCCH format 3 or a PUSCH. Process 500 may also involve processor 412 mapping UCI corresponding to a URLLC service around first DMRSs of the PUCCH format 3 or the PUSCH. Process 500 may further involve processor 412 transmitting the PUCCH format 3 or the PUSCH to the network node.

In some implementations, process 500 may involve processor 412 receiving a configuration of a PUCCH format 3 or a PUSCH. Process 500 may also involve processor 412 multiplexing UCI over the PUCCH format 3 or the PUSCH. Process 500 may further involve processor 412 transmitting the PUCCH format 3 or the PUSCH to the network node.

In some implementations, process 500 may involve processor 412 receiving a configuration of a PUCCH format 3 or a PUSCH. Process 500 may also involve processor 412 modulating UCI with DMRSs of the PUCCH format 3 or the PUSCH. Process 500 may further involve processor 412 transmitting the PUCCH format 3 or the PUSCH to the network node.

In some implementations, the UCI may comprise one or two bits of at least one of an SR, HARQ information, and a CQI.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, a plurality of channel state information (CSI) reports;
determining, by the processor, a priority of each of the plurality of CSI reports according to a service type;
detecting, by the processor, a collision between at least two CSI reports; and
transmitting, by the processor, a CSI report with a higher priority to a network node.

2. The method of claim 1, further comprising:
dropping, by the processor, a CSI report with a lower priority.

3. The method of claim 1, wherein the determining comprises determining the priority of each of the plurality of CSI reports according to a channel quality indicator (CQI) table.

4. The method of claim 1, wherein the determining comprises determining the priority of each of the plurality of CSI reports according to a block error rate (BLER) target.

5. The method of claim 1, wherein the determining comprises determining a high priority to a CSI report associated with an ultra-reliable and low-latency communications (URLLC) service.

6. The method of claim 1, further comprising:
receiving, by the processor, a configuration of a physical uplink control channel (PUCCH) format 3; and
transmitting, by the processor, the PUCCH format 3 in a 2-symbol or 3-symbol duration to the network node by using Discrete Fourier Transform-Spread Orthogonal Frequency Division Multiplexing (DFT-S-OFDM).

7. The method of claim 1, further comprising:
receiving, by the processor, a configuration of a physical uplink control channel (PUCCH) format 3 or a physical uplink shared channel (PUSCH);
mapping, by the processor, uplink control information (UCI) corresponding to an ultra-reliable and low-latency communications (URLLC) service around first demodulation reference signals (DMRSs) of the PUCCH format 3 or the PUSCH; and
transmitting, by the processor, the PUCCH format 3 or the PUSCH to the network node.

8. The method of claim 1, further comprising:
receiving, by the processor, a configuration of a physical uplink control channel (PUCCH) format 3 or a physical uplink shared channel (PUSCH);
multiplexing, by the processor, uplink control information (UCI) over the PUCCH format 3 or the PUSCH; and
transmitting, by the processor, the PUCCH format 3 or the PUSCH to the network node.

9. The method of claim 1, further comprising:
receiving, by the processor, a configuration of a physical uplink control channel (PUCCH) format 3 or a physical uplink shared channel (PUSCH);
modulating, by the processor, uplink control information (UCI) with demodulation reference signals (DMRSs) of the PUCCH format 3 or the PUSCH; and
transmitting, by the processor, the PUCCH format 3 or the PUSCH to the network node.

10. The method of claim 9, wherein the UCI comprises one or two bits of at least one of a scheduling request (SR), hybrid automatic repeat request (HARQ) information, and a channel quality indicator (CQI).

11. An apparatus, comprising:
a transceiver which, during operation, wirelessly communicates with a network node of a wireless network; and
a processor communicatively coupled to the transceiver such that, during operation, the processor performs operations comprising:
generating a plurality of channel state information (CSI) reports;
determining a priority of each of the plurality of CSI reports according to a service type;
detecting a collision between at least two CSI reports; and
transmitting, via the transceiver, a CSI report with a higher priority to the network node.

12. The apparatus of claim 11, wherein, during operation, the processor further performs operations comprising:
dropping a CSI report with a lower priority.

13. The apparatus of claim 11, wherein, in determining the priority of each of the plurality of CSI reports according to the service type, the processor determines the priority of each of the plurality of CSI reports according to a channel quality indicator (CQI) table.

14. The apparatus of claim 11, wherein, in determining the priority of each of the plurality of CSI reports according to the service type, the processor determines the priority of each of the plurality of CSI reports according to a block error rate (BLER) target.

15. The apparatus of claim 11, wherein, in determining the priority of each of the plurality of CSI reports according to the service type, the processor determines a high priority to a CSI report associated with an ultra-reliable and low-latency communications (URLLC) service.

16. The apparatus of claim 11, wherein the processor, during operation, further performs operations comprising:
receiving, via the transceiver, a configuration of a physical uplink control channel (PUCCH) format 3; and
transmitting, via the transceiver, the PUCCH format 3 in a 2-symbol or 3-symbol duration to the network node by using Discrete Fourier Transform-Spread Orthogonal Frequency Division Multiplexing (DFT-S-OFDM).

17. The apparatus of claim 11, wherein the processor, during operation, further performs operations comprising:
receiving, via the transceiver, a configuration of a physical uplink control channel (PUCCH) format 3 or a physical uplink shared channel (PUSCH);
mapping uplink control information (UCI) corresponding to an ultra-reliable and low-latency communications (URLLC) service around first demodulation reference signals (DMRSs) of the PUCCH format 3 or the PUSCH; and
transmitting, via the transceiver, the PUCCH format 3 or the PUSCH to the network node.

18. The apparatus of claim 11, wherein the processor, during operation, further performs operations comprising:
receiving, via the transceiver, a configuration of a physical uplink control channel (PUCCH) format 3 or a physical uplink shared channel (PUSCH);
multiplexing uplink control information (UCI) over the PUCCH format 3 or the PUSCH; and
transmitting, via the transceiver, the PUCCH format 3 or the PUSCH to the network node.

19. The apparatus of claim 11, wherein the processor, during operation, further performs operations comprising:
receiving, via the transceiver, a configuration of a physical uplink control channel (PUCCH) format 3 or a physical uplink shared channel (PUSCH);
modulating uplink control information (UCI) with demodulation reference signals (DMRSs) of the PUCCH format 3 or the PUSCH; and
transmitting, via the transceiver, the PUCCH format 3 or the PUSCH.

20. The apparatus of claim 19, wherein the UCI comprises one or two bits of at least one of a scheduling request (SR), hybrid automatic repeat request (HARQ) information, and a channel quality indicator (CQI).
